(19) United States
(12) Patent Application Publication
(10) Pub. No.: US 2010/0079440 A1
(43) Pub. Date: Apr. 1, 2010

(54) DRIVER FOR IMAGE DISPLAY MEDIUM, IMAGE DISPLAY DEVICE, METHOD FOR INITIALIZING IMAGE DISPLAY MEDIUM, COMPUTER-READABLE MEDIUM AND COMPUTER DATA SIGNAL

(75) Inventors: Yoshiro YAMAGUCHI, Kanagawa (JP); Takayuki TAKEUCHI, Kanagawa (JP); Fuminori TAKIZAWA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/368,669

(22) Filed: Feb. 10, 2009

(30) Foreign Application Priority Data
Sep. 26, 2008 (JP) 2008-247129

(51) Int. Cl. G09G 5/00

(52) U.S. Cl. 345/212

(57) ABSTRACT

There is provided a method for initializing an image display medium. The image display medium includes a pair of substrates, a common electrode, pixel electrodes that are arranged for respective pixels constituting rows and columns on the other substrate, a display layer in which groups of moving particles that move between the substrates in accordance with an electric field are dispersed in a dispersion medium enclosed between the substrates, and transistors that are connected to the pixel electrodes, respectively. Each transistor controls a voltage to be applied to the corresponding pixel. The method includes a first procedure of applying voltages to the source electrodes of the transistors of all the pixels collectively, and a second procedure of applying voltages to the gate electrodes of the transistors of all the pixels collectively while continuing the applying of the voltages in the first procedure.

### CROSS-REFERENCE TO RELATED APPLICATIONS

This application is based on and claims priority under 35 USC 119 from Japanese Patent Application No. 2008-247129 filed on Sep. 26, 2008.

### BACKGROUND

1. Technical Field

The invention relates to a driver for an image display medium, an image display device, a method for initialing the image display medium, a computer-readable medium and a computer data signal.

2. Related Art

An electrophoresis-type image display medium using colored particles has been well known as a repeatedly rewritable image display medium having a memory property. Such an image display medium includes a pair of substrates and plural kinds of particle groups, which are enclosed between the substrates to be movable between the substrates in accordance with an applied electric field and which have different colors and different charging characteristics, for example. Also, a gap member for partitioning the gap between the substrates into plural cells may be provided between the substrates.

In such image display medium, voltages corresponding to an image are applied between the pair of substrates to move the particles, and contrast between the particles having the different colors displays an image. After stopping the application of voltage, the particles keep adhering to the substrates due to the Van dee Waals force or the image force. Thereby, the displaying of the image is kept.

For the purpose of improving the color display property, JP Hei.1-267525 A and JP 2001-312225 A (corresponding to U.S. Pat. No. 6,407,763) have proposed using a colored back substrate in the image display medium having the above configuration as well as the color display with particles.

Also, JP 2004-86095 A (corresponding to U.S. Pat. No. 6,879,430) has proposed a technique that plural kinds of particle groups, which have different adherences to a display substrate and a back substrate, namely, which require different strengths of electric field to start moving, are enclosed in a dispersion medium between the display substrate and the back substrate, and desired particles are selectively moved by forming an electric field having the strength of electric field at which the particle group of the kind in question starts moving in accordance with the kind of particle group in question.

In such an electrophoresis-type image display medium, to form the electric field for controlling the movement of the particle groups, an active matrix method is employed in which a common electrode is provided in the whole area of one of the pair of substrates, and a pixel electrode is arranged on the other substrate for each pixel, and transistors such as TFTs (thin film transistors) are connected to the pixel electrodes (see JP 2007-163987 A (corresponding to US 2007/0139358 A) and JP 2006-227249 A (corresponding to US 2006/0181504 A)). In the active matrix method, gate voltages of the TFTs are scanned for each row and the gates are switched (ON/OFF control) to control the source voltages applied to the pixel electrodes to form a desired image.

In the active-matrix-type image display medium, when an image is reset (initialized) by erasing a written image or the like, gate voltages are scanned for each row and the gates are turned on successively so that a constant source voltage is applied to each pixel to form a preferably uniform monochrome image (see JP 2002-116734 A (corresponding to U.S. Pat. Nos. 6,762,744 and 6,961,047)).

### SUMMARY

According to an aspect of the invention, a driver for an image display medium is provided. The image display medium has a pair of substrates, a common electrode, pixel electrodes, a display layer and transistors. The pair of substrates face each other with a gap. The common electrode is disposed in a whole surface of one of the substrates. The pixel electrodes are arranged for respective pixels constituting rows and columns on the other substrate. In the display layer, groups of moving particles that move between the substrates in accordance with an electric field are dispersed in a dispersion medium enclosed between the substrates. The transistors are connected to the pixel electrodes, respectively. Each transistor controls a voltage to be applied to the corresponding pixel. The driver includes a first voltage application unit, a second voltage application unit and a control unit. In initializing the image display medium and in writing an image into the image display medium, the first voltage application unit can apply voltages to source electrodes of the transistors of all the pixels or each column collectively. The second voltage application unit can select each row of the transistors successively and apply voltages to gate electrodes of the transistors of each selected row. The control unit controls the first voltage application unit and the second voltage application unit. In initializing the image display medium, the control unit controls the first and second voltage application units so that the second voltage application unit applies the voltages to the gate electrodes of the transistors of all the pixels collectively while the first voltage application unit is applying the voltages to the source electrodes of the transistors of all the pixels collectively.

### BRIEF DESCRIPTION OF THE DRAWINGS

Exemplary embodiments of the invention will be described in detail based on the following figures, wherein:

FIG. 1 is a schematic configuration view of an image display device according to one exemplary embodiment of the invention, including a driver for an image display medium according to the exemplary embodiment of the invention;

FIG. 2 is a schematic section view the image display medium shown in FIG. 1 in an initialized state (the whole area thereof displays black color);

FIG. 3 is a schematic section view the image display medium shown in FIG. 1 in a state where the whole area thereof displays red color;

FIG. 4 is a schematic section view the image display medium shown in FIG. 1 in a red white mixed color state that is a transition state leading to a state where the whole area thereof displays white color;

FIG. 5 is a schematic section view of the image display medium shown in FIG. 1 in the state where the whole area thereof displays the white color;

FIG. 6 is a schematic section view of the image display medium in a state where a mixed-color display image has been written therein;

FIG. 7 is a schematic chart showing a sequence control of a source driver IC and a gate driver IC according to a first exemplary embodiment;

FIG. 8 is a schematic chart showing a sequence control of the source driver IC and the gate driver IC, without the configuration of the invention being provided;

FIG. 9 is a voltage transition graph for explaining a voltage application time to each pixel in an initialization method for scanning pixels and applying a gate voltage to each pixel;

FIG. 10 is a graph showing the voltage transition for explaining the voltage application time to each pixel according to the first exemplary embodiment;

FIG. 11 is a flowchart showing an operation example of applying the voltages in rewriting an image on the image display medium (from initialization to writing of the image);

FIG. 12 is a graph showing a sequence of voltage application in the flowchart for the operation of applying the voltages shown in FIG. 11;

FIG. 13 is a schematic chart showing a sequence control of the source driver IC (first voltage application unit) and the gate driver IC (second voltage application unit) according to a second exemplary embodiment;

FIG. 14 is a schematic chart showing a sequence control of the source driver IC (first voltage application unit) and the gate driver IC (second voltage application unit) according to a third exemplary embodiment;

FIG. 15 is a schematic chart showing a sequence control of the source driver IC (first voltage application unit) and the gate driver IC (second voltage application unit) according to a fourth exemplary embodiment;

FIG. 16 is a graph showing a pulse waveform of a source voltage according to the fourth exemplary embodiment and a pulse waveform of so-called rectangular wave having the same pulse width, along the same time axis (transverse axis);

FIG. 17 is a graph showing transition of current flowing between each pixel when the voltages having the respective pulse waveforms shown in FIG. 16 are applied thereto, along the same time axis (transverse axis);

FIG. 18 is a graph showing pulse waveforms of source voltages according to a fifth exemplary embodiment and pulse waveforms of so-called rectangular waves with the same pulse width, along the same time axis (transverse axis); and

FIG. 19 is a block diagram for explaining an initialization program for the image display medium according to the exemplary embodiments of the invention.

### DETAILED DESCRIPTION

### Exemplary Embodiments

Exemplary embodiments of the invention will be described below in detail with reference to the accompanying drawings.

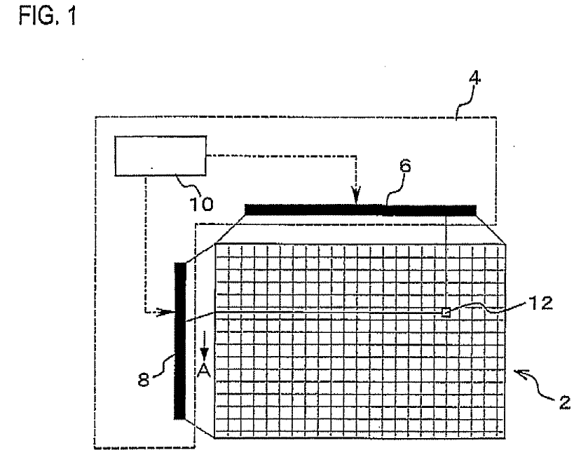

FIG. 1 is a schematic configuration view of an image display device according to one exemplary embodiment of the invention, including a driver for an image display medium (hereinafter may be referred to as a “driver”) according to the exemplary embodiment of the invention. FIG. 1 schematically shows a state where one pixel of a TFT is selected. The image display device of this exemplary embodiment includes an image display medium 2 and a driver 4 for driving this image display medium 2, as shown in FIG. 1.

<Image Display Medium>

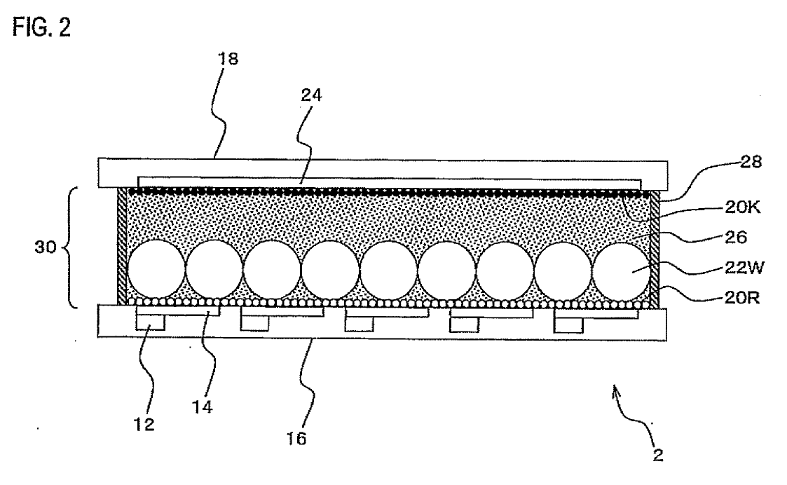

The image display medium 2 is schematically shown in a plan view of FIG. 1 and in a section view of FIG. 2. Herein, FIG. 2 is a schematic section view of the image display medium 2 shown in FIG. 1 in an initialized state. In FIG. 2, the image display medium 2 is drawn by picking up five pixels to explain its configuration more clearly, but actually more pixels are arranged like a lattice in rows and columns.

The image display medium 2 is configured so that one pair of substrates (back substrate 16 and display substrate 18) sandwich a display layer 30 containing electrophoretic particles (moving particles) therebetween, as shown in FIG. 2. In FIG. 2, to explain the configuration of the image display medium 2 more clearly, the actual size ratio between respective components is not reflected, and particularly the moving particles and the inter-substrate distance (spacing between the back substrate 16 and the display substrate 18) are greatly enlarged in the drawing, but in practice, the moving particles and the inter-substrate distance are much smaller than the illustrated sizes.

The display layer 30 contains positively charged black particles (moving particles) 20K, negatively charged red particles (moving particles) 20R, and negatively-charged and large-diameter white particles (moving particles) 22W hang a larger particle diameter than the black and red particles. The positively charged black particles 20K, the negatively charged red particles 20R and the negatively-charged and large-diameter white particles 22W are dispersed in a dispersion liquid (dispersion medium) 26 having transparency and are enclosed therein. The four sides at the end of the back substrate 16 and the display substrate 18 are closed by a spacer 29 with the dispersion liquid 26 containing all the particles hermetically sealed inside.

Both the large-diameter white particles 22W and the red particles 20R are negatively charged particles, and the large-diameter white particles 22W require a larger force to separate from a substrate than the red particles 20R. When the large-diameter white particles 22W are moved between the substrates, it is required to apply a larger voltage than when the red particles 20R are moved. Also, the black particles 20K and the red particles 20R are charged with different polarities, that is positive and negative, and the black particles 20K require a larger force to separate from a substrate than the red particles 20R. When the black particles 20K are moved between the substrates, it is required to apply a larger voltage in absolute value than when the red particles 20R are moved. The black particles 20K require a smaller force to separate from a substrate than the large-diameter white particles 22W. When the large-diameter white particles 22W are moved between the substrates, it is required to apply a larger voltage in absolute value than when the black particles 20K are moved.

The black particles 20K may be black pigment particles such as carbon black, manganese ferrite black or titanium black. The red particles 20R may be red pigment particles such quinacridone red, cadmium red or lake red. Also, the large-diameter white particle 22W may be particles containing a white pigment such as titanium oxide, silicon oxide or zinc oxide, for example, that are dispersed in polystyrene, polyethylene, polypropylene, polycarbonate, polymethyl methacrylate (PMMA), acrylic resin, phenol resin or formaldehyde condensate. Also, when particles other than white are used as particles making up a colored member, for example, the above resin particles containing a pigment or dye of desired color may be used. If the pigment or dye has RGB or YMC color, for example, a typical pigment or dye used for the printing ink or color toner may be used.

The volume-average particle diameter of the moving particles such as the black particle 20K and the red particle 20R is typically, but not limited to, in a range of from 0.01 to 10 μm, and preferably in a range of from 0.03 to 3 μm. If the volume-average particle diameter of the moving particles is smaller than the lower limit of the above range, charge amounts of the moving particles may become small, and the speed of the moving particles in the transparent liquid may be slow. That is, the display response may be extremely decreased. To the contrary, if the volume-average particle diameter of the moving particles is larger than the upper limit of the above range, the following performance would be excellent, but sedimentation due to its weight or deterioration of memory effect might be likely to occur. Also, since the large-diameter white particles 22W are required to have a larger diameter by one digit or more, the gap between the display substrate 18 and the back substrate 16 has to be larger, which possibly decreases the display response or increases the drive voltage for moving the particles as will be described later.

The large-diameter white particles 22W have a larger particle diameter than the black particles 20K and the red particles 20R, and preferably have a particle diameter ten or more times as large as the black particles 20K and the red particles 20R, because it is required that these small diameter particles can move through the inter-particle spacings between the large-diameter white particles 22W. In the case where there is a variation in the diameter of black particles 20K or red particles 20R and the black particle 20K or red particle 20R having a large particle is contained, if the large-diameter white particles 22W have the diameter twenty or more times as large as the black particles 20K and the red particles 20R, the black particle 20K or red particle 20R having the large particle would not be clogged between the large-diameter white particles 22W. Thereby, the display performance is stabilized. Since the large-diameter white particles 22W also serve as the moving particles, which move between the substrates, it is required that the particle diameter thereof is sufficiently smaller than the inter-substrate distance, and is preferably one-fifth or less of the inter-substrate distance.

If the particle diameter of the large-diameter white particles 22W is too small, the inter-particle spacing for allowing the black particles 20K and the red particles 20R to move may not be sufficiently secured in some cases. If the particle diameter of the large-diameter white particle 22W is too large, it is required to increase the substrate gap, which might causes a higher voltage or a lower display speed. If the volume-average particle diameter of the large-diameter white particles 22W is about 10 μm, the moving particles having the volume-average particle diameter as small as a few tens nm can move through the spacing between the large-diameter white particles 22W.

In this exemplary embodiment, the black particles 20K and the red particles 20R have a volume-average particle diameter of 0.05 μm, and the large-diameter white particles 22W has a volume-average particle diameter of 10 μm.

The dispersion liquid 26 having transparency is preferably highly insulating, colorless and transparent, and may be any of various kinds of solvent such as isoparaffin, silicon, toluene, xylene, or normal paraffin, for example.

The thickness of the display layer 30, namely, the inter-substrate distance (spacing between the back substrate 16 and the display substrate 18) is selected in a range of from 30 μm to 300 μm under the condition that it is larger than the diameter of the large-diameter white particles 22W, and preferably in the range of from 40 μm to 60 μm.

The back substrate 16 and the display substrate 18 are members intended to hold the display layer 30 on the inside surfaces thereof and maintain the structure of the image display medium 2. These substrates 16, 18 are formed of sheet-like materials having the strength capable of withstanding the external force. Examples of the specific material of the substrates 16, 13 include an inorganic sheet (e.g., glass silicon), and a polymer film (e.g., polyethylene terephthalate, polysulfone, polyethersulfone, polycarbonate, polyethylene naphthalate). At least, the display surface of the display substrate 18 has a function of transmitting light. On the outside surface, a well-known functional film such as an anti-contamination film, an abrasion proof film, a light reflection preventive film or a gas barrier film may be formed.

The display substrate 18 has a common electrode 24 disposed in the whole area thereof. Also, the back substrate 16 has a pixel electrode 14 that are arranged for each pixel. These electrodes 14, 24 may be specifically a conductive thin film made of metal (e.g., gold, silver, copper, iron or aluminum), metallic oxide (e.g., indium oxide, tin oxide or indium tin oxide (ITO)), carbon, a complex in which the above materials are dispersed in polymer, or a conductive organic polymer (e.g., polythiophene or polyaniline). A well-known functional film such as an adherence enhancement film, a light reflection preventive film or a gas barrier film may be formed on the surface.

Spacers 28 have a function of keeping the spacing between the back substrate 16 and the display substrate 18 constant, as well as a function of sealant as already described. The materials of the spacers 28 are not specifically limited, but may or may not be the same as the back substrate 16 or the display substrate 18.

A TFT (thin film transistor) 12 is arranged so as to correspond to each pixel electrode 14, and connected to a source electrode. As the TFT 12, appropriate and optimal element may be selected in accordance with desired specifications. The invention is not limited to the TFT, but various kinds of transistor may be employed. The thin film field effect transistor (FET) is suitable as a switching element.

<Driver>

A driver 4 includes a source driver IC (an example of a first voltage application unit) 6 that applies source voltages to the individual TFTs 12 included in the image display medium 2, a gate driver IC (an example of a second voltage application unit) 8 that applies gate voltages to them, and a control unit (an example of a control unit) 10 that controls these driver ICs 6, 8.

The source driver IC 6 is configured to apply the source voltages to the TFTs 12 of all the pixels or each pixel column collectively. In this specification, the term “collectively” means that timings of applying the source voltages are the same, but does not mean that waveforms or phases of the voltages for all the pixels are identical. In practice, the case where a phase is shifted for each pixel will be exemplified in an exemplary embodiment described later.

The gate driver IC 8 is configured to be able to select (i.e., scans) pixel rows successively and apply the gate voltages to the TFTs 12 of each selected pixel row. Also, the gate driver IC 8 is configured to be able to turn ON/OFF the gate voltages for all the pixels simultaneously. In FIG. 1, the arrow A schematically indicates a state where the gate driver IC 8 scans and applies the gate voltages.

And, the control unit 10 controls waveforms of the source voltages applied from the source driver IC 6 and the ON/OFF switching of the gate voltages applied from the gate driver IC 8. Under these controls, the source voltages to be applied to the pixel electrodes 14 are controlled on the pixel basis, so that a desired color display image is written at the image writing time. The actual control will be detailed later in the sections <Driving at the Image Writing Time> and <Driving at the Time of Initializing the Image Display Medium>.

<Driving at the Image Writing Time>

The driving control at the image writing time in the image display device shown in FIG. 1 will be described below.

In a state of the image display medium 2 shown in FIG. 2, the black particles 20K adsorb to the whole area of the display substrate 18 and the other particles adsorb to the back substrate 16, thereby producing the whole area black color display with the black particles 20K as seen from the display-surface side (the display substrate 18 side). In this exemplary embodiment, this state of the black color display is the initialized state of the image display medium 2.

In this specification, the term “initialization” means a state where a monochrome and uniform display image is formed in the whole area, but not limited to the black color. With regard to the image display medium 2 according to this exemplary embodiment, the concept of “initialization” covers an action of forming a monochrome and uniform display image in the whole area, in black, red, white or an intermediate color among black, red and white.

The operation for initialization will be detailed later in the section <Driving at the Time of Initializing the Image Display Medium>.

A driving operation to obtain a monochrome display image having each color in the whole area will be briefly described below.

(Red Color Display)

The source driver IC 6 is controlled so that the common electrode 24 becomes negative and the pixel electrodes 14 become positive, to apply the source voltages to the TFTs 12 collectively, and the gate driver IC 8 scans to apply the gate voltages to bring the TFTs 12 of all the pixels into an ON state successively. At this time, the drive voltages applied to the respective pixels are large enough to move the red particles 20R to the display substrate 18 and move the black particles 20K to the back substrate 16, but can not move the large-diameter white particles 22W to the display substrate 18.

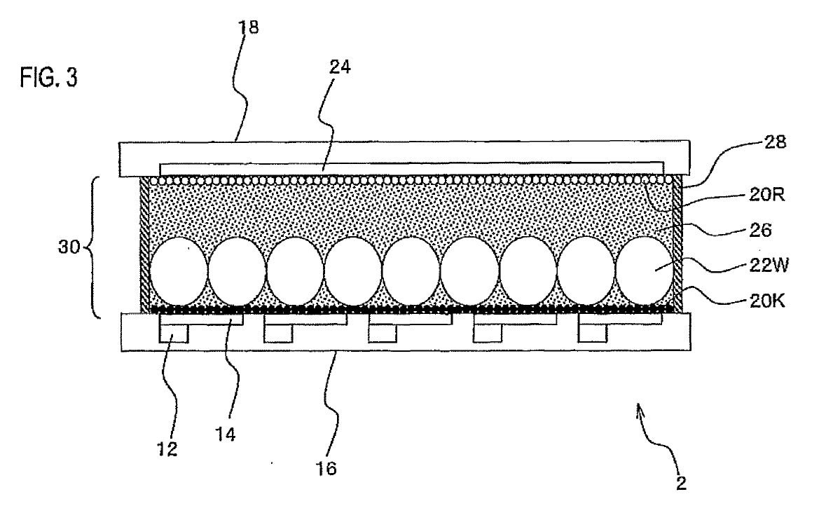

Thereby, the whole area red color display with the red particles 20R is obtained as seen from the display-surface side (the display substrate 18 side) in a state where the red particles 20R adsorb to the whole area of the display substrate 18, and the other particles adsorb to the side of the back substrate 16 as shown in FIG. 3. Herein, FIG. 3 is a schematic section view of the whole area red color display of the image display medium shown in FIG. 1.

Even if a DC drive voltage having a fixed magnitude is applied, there may be a case where the moving particles remain on the substrate surface and move less sufficiently. Therefore, it is preferable to apply, as the source voltages, AC waveform pulses that are large enough to move target moving particles and separate the target moving particles from a substrate surface, and it is preferable that the final waveforms of the AC waveform pulses have a target polarity and a target magnitude. This applies to not only the case of driving the image display medium into the other display states in this exemplary embodiment but also broadly applies to the case of driving the electrophoresis-type image display medium.

(White Color Display)

First of all, the source driver IC 6 is controlled so that the common electrode 24 becomes negative and the pixel electrodes 14 becomes positive, to apply the source voltages to the TFTs 12 collectively, and the gate driver IC 8 scans to apply the gate voltages to bring the TFTs 12 of all the pixels in the ON state. At this time, the drive voltages applied to the respective pixels are large enough to move the large-diameter white particles 22W to the display substrate 18 and move the black particles 20K to the back substrate 16. Then, the red particles 20R, which are movable at a smaller voltage, also move to the display substrate 18.

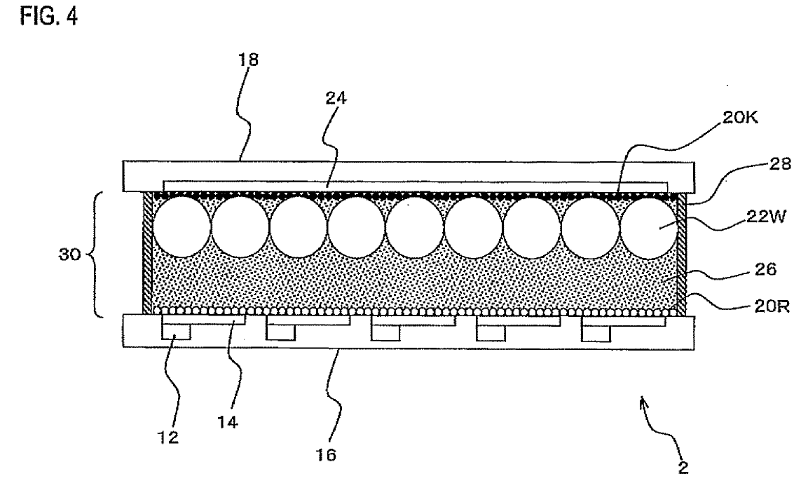

Thereby, the red particles 20k and the large-diameter white particles 22W adsorb to the whole area of the display substrate 18, and the black particles 20K adsorb to the side of the back substrate 16, as shown in FIG. 4. In this state, the color display is a mixture of the red color with the red particle 20R and the white color with the large-diameter white particle 22W, as seen from the display-surface side (the display substrate 18 side). Herein, FIG. 4 is a schematic section view in a red-white mixed color state that is a transition state leading to the whole area white color display of the image display medium shown in FIG. 1.

Further, at this time, the source driver IC 6 is controlled so that the common electrode 24 becomes positive and the pixel electrodes 14 become negative to apply the source voltages to the TFTs 12 collectively, and the gate driver IC 8 scans to apply the gate voltages to bring the TFTs 12 of all the pixels in the ON state. At this time, the drive voltages applied to the respective pixels are large enough to move the red particles 20R to the back substrate 16 but can not move the black particles 20K to the back substrate 18. Also, the large-diameter white particles 22W having a greater moving voltage in absolute value can not move from the display substrate 18 to the back substrate 16.

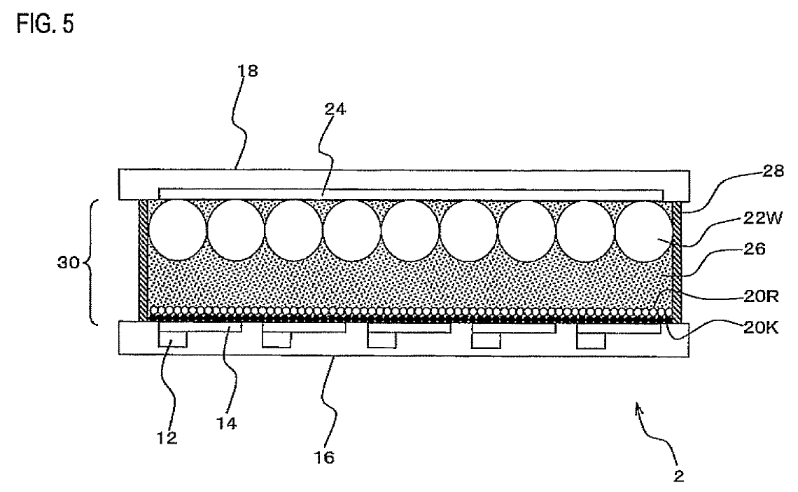

Thereby, the image display medium is placed in a state where the large-diameter white particles 22W adsorb to the whole area of the display substrate 18, and the other particles adsorb to the side of the back substrate 16, as shown in FIG. 5. Thereby, the whole area white color display with the large-diameter white particles 22W is made, as seen from the display-surface side (the display substrate 18 side). Herein, FIG. 5 is a schematic section view in the whole area white color display of the image display medium shown in FIG. 1.

(Black Color Display)

Since the black color display is the same as the initialized state, it is unnecessary to drive the image display medium to obtain the whole area black color display.

In actually writing an image, the gate driver IC 8 scans to bring the TFTs 12 of target pixels into an OFF state either at the writing time for obtaining the red color display or at the writing time for obtaining the white color display. Then, the black color display with the black particles 20K is obtained with the target pixels, which remain in the initialized state.

(Writing a Mixed-Color Display Image)

A desired mixed-color display image can be written into the image display medium 2 by controlling the respective operations for the red color display, the white color display and the black color display as described above on the pixel basis.

More specifically, first of all, the writing for producing the red color display is performed, and the gate driver IC 8 scans to bring the TFT 12 of only pixels that are desired to perform the red color display into the ON state. Next, the writing for producing the white color display is performed. When the source voltage is applied twice, the gate driver IC 8 scans to bring the TFT 12 of only pixels that are desired to perform the white color display into the ON state.

By performing the above scanning operation three times (once for red color, and twice for white color), the pixels desired to perform the red color display are changed to the red color, and the pixels desired to perform the white color display are changed to the white color. Also, by turning OFF the TFT 12 in driving the image display medium in both of the drivings for the red and white colors, the pixels desired to perform the black color display while remaining in the initialized state perform the black color display. Thereby, the mixed-color display image of three colors of red, white and black is written.

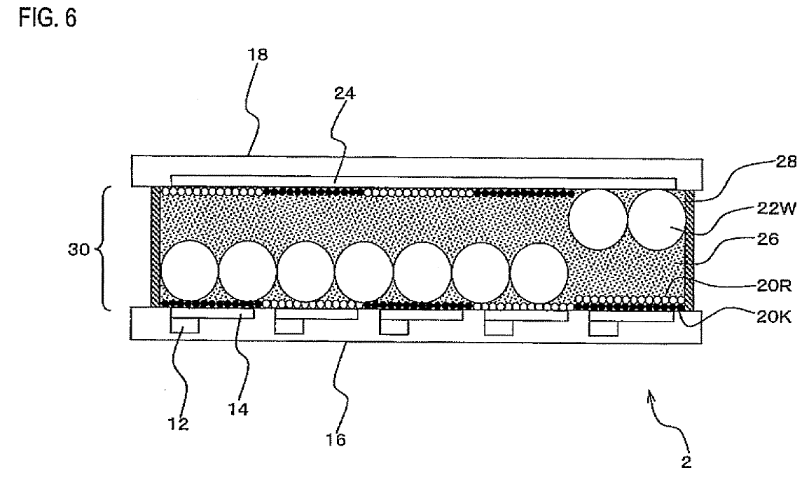

FIG. 6 is a schematic section view of the image display medium 2 in a state where a mixed-color display image is written in the above described manner, in which the five pixels in the figure show colors of red, black, red, black and white in order from the left.

<Driving at the Time of Initializing the Image Display Medium>

The driving at the time of initializing the image display medium will be described below.

In the following explanation, control that is performed using the above described image display device will be described as first to fifth exemplary embodiments.

### First Exemplary Embodiment

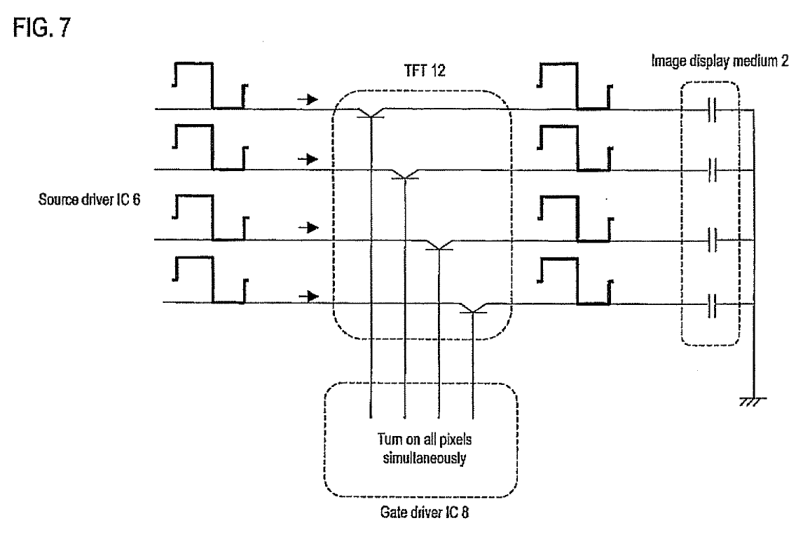

FIG. 7 is a schematic chart showing a sequence control of the source driver IC 6 and the gate driver IC 8 according to the first exemplary embodiment. In this exemplary embodiment, the source driver IC 6 and the gate driver IC 8 are controlled by the control unit 10 in accordance with this chart

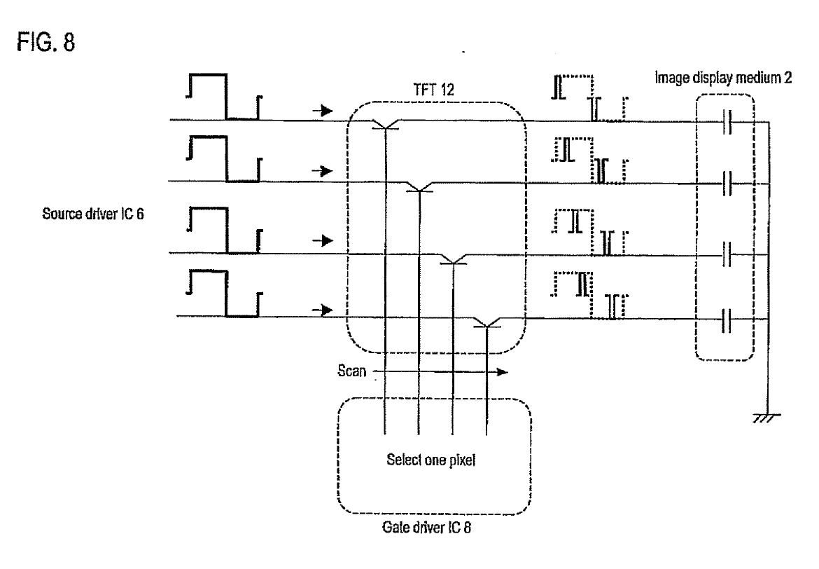

On the other hand, FIG. 8 is a schematic chart showing a sequence control of the source driver IC 6 and the gate driver IC 8 without the configuration of the invention being provided. In the case where the configuration of the invention is not provided, the source driver IC 6 and the gate driver IC 8 are controlled by the control unit 10 in accordance with the chart of FIG. 8.

In the sequence control at the time of initialization shown in FIG. 8, a monochrome uniform image in the whole area is formed in a similar manner to through a similar operation to that at the time of writing an image. That is, in a state where predetermined pulse voltages (source voltages) are applied to the TFTs 12 from the source driver IC 6, the gate driver IC 8 scans to bring the pixels into the ON state successively and apply the source voltages thereto as the drive voltages. The image display medium has a great number of pixels and takes a lot of time to scan all the pixels.

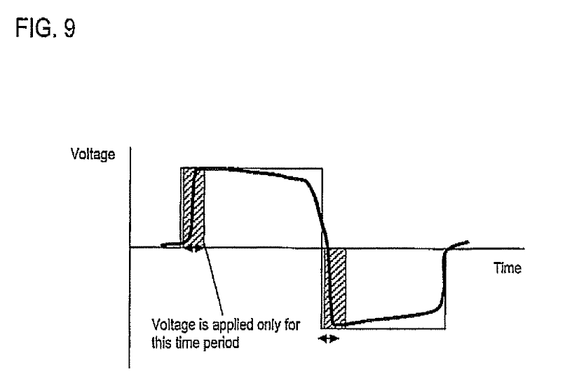

Also, when all the pixels are scanned, it is general to bring the gates into the ON state for only a part of each pulse and repeat this operation for each pulse, in order to apply a pulse voltage of alternating voltage. In the method for scanning and applying the gate voltages to the respective pixels, the voltages are applied for only a part of each pulse as indicated by the oblique line part in FIG. 9. Particularly, since an electronic paper for office has a few thousands of scan lines, the pixel-unit time for which the initialization (reset) voltage can be applied becomes extremely short. Herein, FIG. 9 is a graph showing the voltage transition for explaining a voltage application time to each pixel with the initialization method for scanning and applying the gate voltages to the respective pixels.

At a time of no-scanning, an electric field is formed with holding charges. Thereby, the capacitance caused by dielectric constant is different for each pixel, and the charge mobilities in the TFTs are different. Also, since the wiring resistance is different for each pixel, the charge amount applied is different, if the application time of voltage is not sufficient, so that the voltages applied to the pixels are different. Accordingly, in order to secure the sufficient initialization voltage for all the pixels, it is desirable to take some time period for applying voltages.

Also, in the electrophoresis-type image display medium to which the exemplary embodiments of the invention are directed, a response of the moving particles is slower than the liquid crystal, for example, so that the strength of electric field required for initialization is greater than the liquid-crystal-type image display medium.

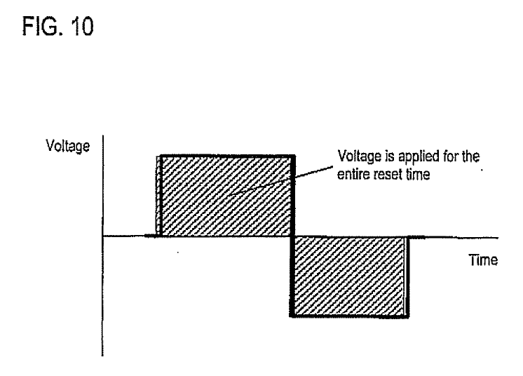

In the configuration according to the exemplary embodiments of the invention, pulse voltages applied by the source driver IC 6 are the same as those in the example shown in FIG. 9, but the gate driver IC 8 collectively applies the gate voltages to all the pixels to simultaneously bring all the pixels into the ON state, without scanning, as shown in FIG. 8. Therefore, the initialization voltages can be applied to the respective pixels for the entire reset (initialization) time. Thereby, as shown in FIG. 10, the reset time can be shortened while securing the required voltage application time, as compared with the method for scanning each pixel. Also, since the long voltage application time can be secured, the more initialization voltages can be applied to the respective pixels. Thereby, the initialized image, which is further uniform in the whole area, can be easily obtained. Herein, FIG. 10 is a graph sowing the voltage transition for explaining the voltage application time to each pixel according to this exemplary embodiment.

A sequence of voltage application from initializing of the image display medium to writing of an image will be described below.

In writing an image, the gate driver IC 8 scans to perform the ON/OFF control for each pixel with the gate voltage as described above. It is desirable that the sequence of the control unit 10 is designed to control the initialization for applying the gate voltages to all the pixels collectively before controlling of the image writing. For example, a logic is formed so that controlling of the initialization for applying the gate voltages to all the pixels collectively is performed in the first line of an image writing signal to the gate driver IC 8.

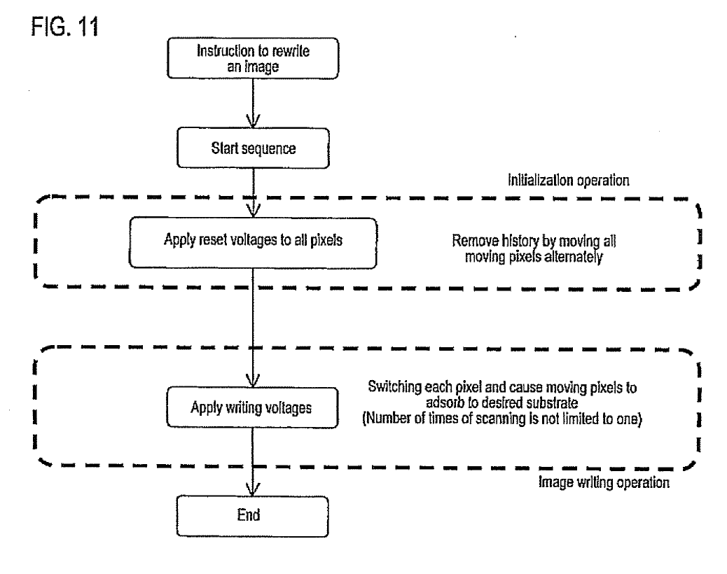

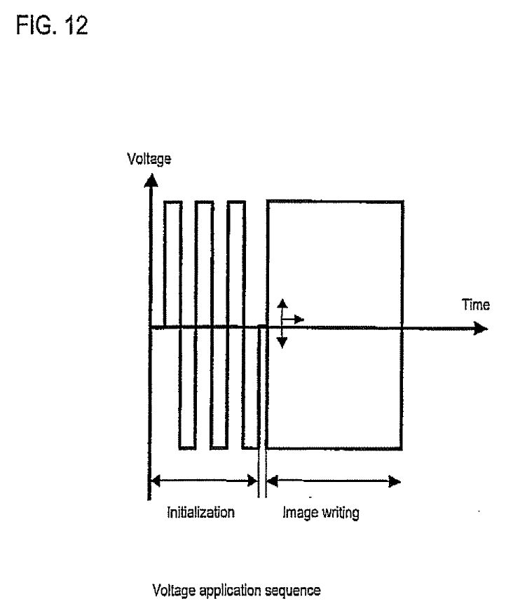

FIG. 11 is a flowchart showing one example of the operation of applying voltages at the time of rewriting an image into the image display medium 2 (from initialization to writing of an image). Also, FIG. 12 shows a sequence of voltage application in the flowchart for the operation of applying the voltages shown in FIG. 11. If an instruction of rewriting an image is input into the control unit 10, the sequence starts to firstly perform the initialization operation. The initialization operation is performed as described above. All the moving particles are alternately moved between the display substrate 18 and the back substrate 16 by pulse voltages in the initialization operation to erase an image history. And, a predetermined initialization display, that is, a monochrome and uniform display image in the whole area is produced, and the operation transfers to the next step.

The image writing operation at the next step scans the gate voltages to bring each pixel into the ON/OFF state while appropriately controlling and applying the source voltages, so that the drive voltage for writing an image is applied to the display layer 30. This scanning operation is varied depending on the number of moving particles, and is performed three times in this exemplary embodiment as described above. This image writing operation switches each pixel and causes the moving particles to adsorb to the desired substrates, thereby obtaining a display image. Since this image writing operation varies for each scan and for each pixel, FIG. 12 shows a simple rectangular figure. However, a voltage having a desired waveform is of course applied as the drive voltage to each pixel.

In the image writing operation, scanning of the gate voltage is performed for all the pixels (when scanning is performed plural times, all the scans are performed), and the sequence of rewriting the image is ended.

In the above way, the display image is rewritten.

Although the sequence of voltage application according to this exemplary embodiment has been described above, it should be noted that the same sequence may also be performed in each of the following exemplary embodiments.

### Second Exemplary Embodiment

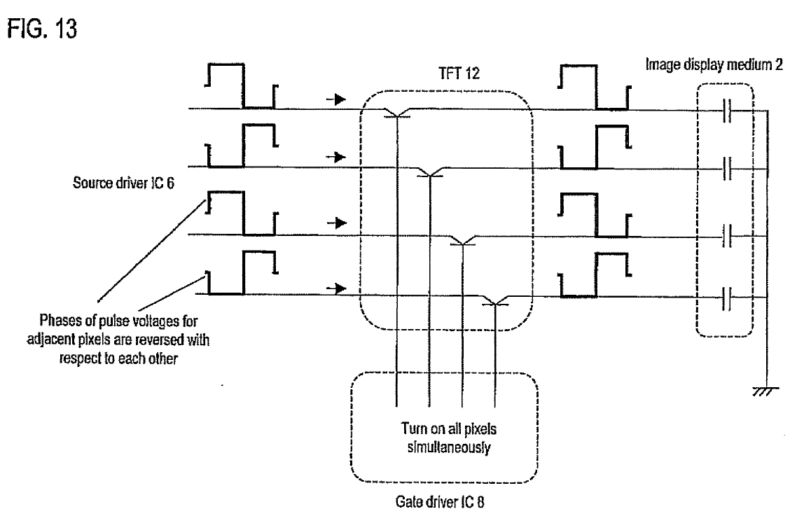

FIG. 13 is a schematic chart showing a sequence control of the source driver IC 6 and the gate driver IC 8 according to a second exemplary embodiment. In this exemplary embodiment, the source driver IC 6 and the gate driver IC 8 are controlled by the control unit 10 in accordance with this chart.

In this exemplary embodiment, like the first exemplary embodiment shown in FIG. 10, the gate voltages are applied collectively to all the pixels by the gate driver IC 8 to bring all the pixels into the ON state simultaneously, as shown in FIG. 13. Therefore, the same effect as the first exemplary embodiment can be obtained, that is, the initialization voltage can be applied to each pixel for the entire reset (initialization) time. Thereby, the reset time can be shortened while securing the required application time. Also, the more initialization voltage can be applied to each pixel because the long application time can be secured, and the more uniform initialized image in the whole area can be easily produced in the same way, as compared with the method for scanning each pixel.

In this exemplary embodiment, the pulse voltages (source voltages) provided by the source driver IC 6 are controlled so that phases of the pulse voltages for adjacent pixels are reversed with respect to each other, unlike the first exemplary embodiment.

While the initialization operation is being performed, the whole area monochrome images having different colors that are caused by the pulse voltages which are inverted between positive and negative polarities are alternately displayed on the display surface (surface of the display substrate 18) of the image display medium 2, which repeats rapidly and produces a so-called flicker (flickering).

In this exemplary embodiment, since the source voltages are controlled to be reversed in phase between the adjacent pixels, the display image has an intermediate color of the display image produced by both the positive and negative voltages. In this exemplary embodiment, the intermediate color between the whole area black color display with the black particles 20K and the mixed color display of the red color with the red particles 20R and the white color with the large-diameter white particles 22W is produced as a slightly dense gray color. And, since this gray color display is continued the flicker is resolved or suppressed in this exemplary embodiment even during the initialization operation.

To achieve the effect of resolving or suppressing the flicker, it is not necessarily required that the phases of the pulse voltages are reversed between the adjacent pixels as in this exemplary embodiment. If phases are shifted to some extent, the flicker is suppressed as compared with the in-phase stare where the completely reversed images are alternately displayed in the whole area.

Also, the pixels to which the pulse voltages having the phases reversed or shifted are applied are not necessarily required to be adjacent pixels. If these pixels are mixed, whether regularly or randomly, the flicker is resolved or suppressed. The effect of resolving or suppressing the flicker varies depending on the degree of mixture. It is preferable that those pixels are mixed to the extent that the display image having the intermediate color is visible uniformly in the whole area when the pixels get still and display in a state where any of two colors is selected.

Further, although a percentage of pixels to be reversed is half in his exemplary embodiment, even if the percentage is offset such as 6:4 or 7:3, the flicker is suppressed as compared with the case where the phases are not shifted in which the completely reversed images are alternately displayed in the whole area.

For any of these variation factors (arrangement and percentage of pixels having different phases), if the effect of suppressing the flicker appears even with the variation as compared with the case where the phases are not shifted in which the completely reversed images are alternately displayed in the whole area, it is included in the concept of “mixture” according to this exemplary embodiment of the invention. This concept similarly applies to not only this exemplary embodiment in which the source voltages are applied with phase shift by dividing the phases into two, but also the case where the phases are shifted in three or more ways (four phases in the third exemplary embodiment).

With the configuration of this exemplary embodiment, the effect of suppressing an instantaneous increase in current value caused by a rapid rise of the source voltage is further achieved. This effect will be detailed later in a fifth exemplary embodiment.

### Third Exemplary Embodiment

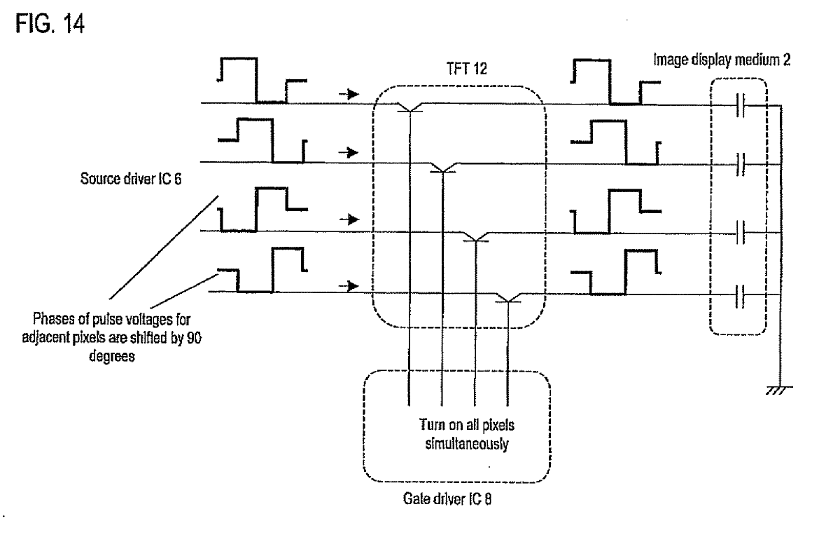

FIG. 14 is a schematic chart showing a sequence control of the source driver IC 6 and the gate driver IC 8 according to a third exemplary embodiment. In this exemplary embodiment, the source driver IC 6 and the gate driver IC 8 are controlled by the control unit 10 in accordance with this chart.

In is exemplary embodiment, like the first exemplary embodiment shown in FIG. 10 or the second exemplary embodiment shown in FIG. 13, the gate voltages are applied collectively to all the pixels by the gate driver IC 8 to bring all the pixels into the ON state simultaneously, as shown in FIG. 14. Therefore, the same effect as the first exemplary embodiment can be obtained, that is, the initialization voltage can be applied to each pixel for the entire reset (initialization) time. Thereby, the reset time can be shortened while securing the required application time. The more initialization voltage can be applied to each pixel because the long application time can be secured, and the initialized image more uniform in the whole area can be easily produced in the same way, as compared with the method for scanning each pixel.

In his exemplary embodiment, the pulse voltages (source voltages) provided by the source driver IC 6 are controlled so that phases of the pulses voltages are shifted by 90° between the adjacent pixels, unlike the first exemplary embodiment and the second exemplary embodiment.

In a two-color image having white and black, if the phases are reversed between the adjacent pixels as in the second exemplary embodiment, a gray color that is an intermediate color of white and black color display is produced. But, in the case of using the moving particles composed of plural kinds of particle groups, such as the case of using three colors of red, white and black as in this exemplary embodiment, the gray color is not produced by merely reversing the phases.

Since the red particle 20R, the black particle 20K and the large-diameter white particle 22W in this exemplary embodiment are different in force required for separation from the substrate, the time required to move each of them is different. For example, when the red-white mixed color display state shown in FIG. 4 is changed to the black color display state shown in FIG. 2 with the polarity of application voltages being reversed, the transition state passes through the state of FIG. 5 where only the red particles 20R are attracted to the back substrate 16.

In this way, since there is a difference in moving speed between the moving particles, the flicker occurs due to a transient color though the performance is of course greatly improved by reversing the phases as in the second exemplary embodiment. In this exemplary embodiment, the phases of the pulse voltages are shifted by 90° between the adjacent pixels. Therefore, it is possible to suppress the flicker at higher dimension by causes the mixed color to include the transient color and to have more gray hue in this exemplary embodiment.

In this exemplary embodiment, it is not required that phases are shifted by 90° between pixel groups. The phases are shifted by a divider of 360°, and several pixels may be arrayed periodically, for example. Or, the pixels may be arranged at any angle or at random period. The concept of “mixture” as described above applies to the way of arrangement.

With the configuration of this exemplary embodiment, the effect of suppressing an instantaneous increase in current value caused by a rapid rise of the source voltages is further achieved. This effect will be detailed in the fifth exemplary embodiment.

### Fourth Exemplary Embodiment

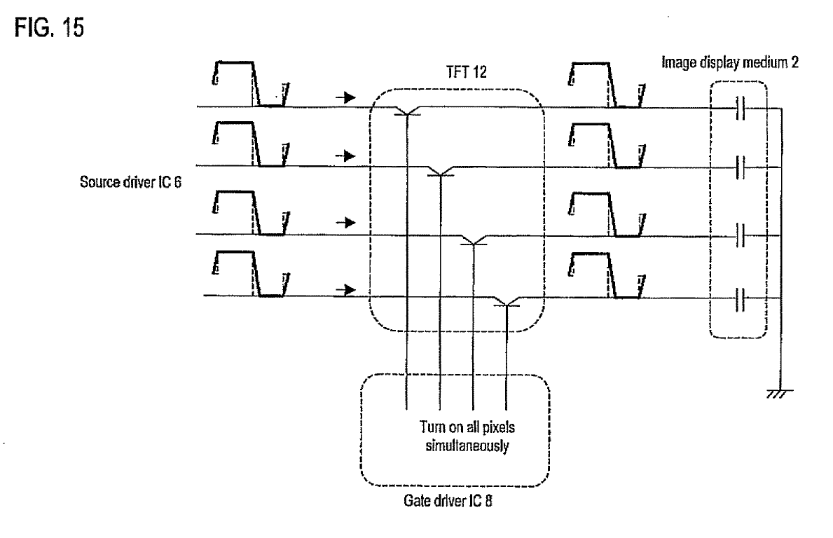

FIG. 15 is a schematic chart showing a sequence control of the source driver IC 6 and the gate driver IC 8 according to a fourth exemplary embodiment. In this exemplary embodiment, the source driver IC 6 and the gate driver IC 8 are controlled by the control unit 10 in accordance with this chart.

In this exemplary embodiment, like the first exemplary embodiment shown in FIG. 10, the gate voltages are applied collectively to all the pixels by the gate driver IC 8 to bring all the pixels into the ON state simultaneously, as shown in FIG. 15. Therefore, the same effect as the first exemplary embodiment can be obtained, that is, the initialization voltage can be applied to each pixel for the entire reset (initialization) time. Thereby, the reset time can be shortened while securing the required application time. The more initialization voltage can be applied to each pixel because the long application time can be secured, and the initialized image more uniform in the whole area can be easily produced in the same way, as compared with the method for scanning each pixel.

In this exemplary embodiment, the waveforms of pulse voltages (source voltages) provided by the source driver IC 6 are controlled to have gradients in rising portions of the respective pulses, that is, so that the applied voltages increase gradually, unlike the first exemplary embodiment.

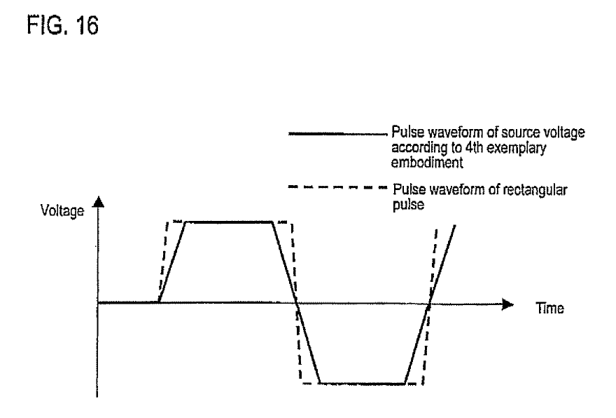

FIG. 16 is a graph showing a pulse waveform of a source voltage according to this exemplary embodiment and a pulse waveform of a so-called rectangular wave having the same pulse width, along the same time axis (transverse axis). The rising portion of each pulse of this exemplary embodiment is gentler than that of the so-called rectangular wave, as seen from FIG. 16.

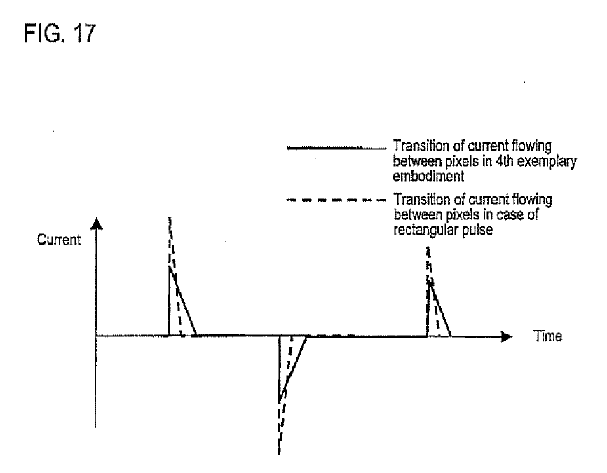

FIG. 17 is a graph showing transition of current flowing between each pixel when the voltages having the respective pulse waveforms shown in FIG. 16 are applied thereto, along the same time axis (transverse axis). In the so-called rectangular wave, it can be found that the current value abruptly increases due to a steep rise of the voltage in each pulse. In the configuration according to this exemplary embodiment in which the gate driver IC 8 performs switching so as to apply the source voltages collectively to all the pixels, an increase in current value at the rising portion of the pulses occurs in all the pixels simultaneously (except the case where the phases of pulses are shifted). Thereby, an instantaneous large current flows at once. Therefore, it is required to prepare the power supply unit having a sufficient capacity and each driver IC and other electric components that are capable of withstanding the large current.

In this exemplary embodiment, each pulse is controlled to rise gently by suppressing a rapid rise of voltage. In this case, an instantaneous increase in current value is suppressed. Thereby, the maximum current value can be restrained to be low as shown in FIG. 17. Therefore, it is possible to select the power supply unit having a lower capacity and select driver ICs and other electric components having lower durability against a large current. Thus, the degree of freedom in design increases. Also, reduction in size and cost of the image display medium and the image display device can be achieved.

In order to output the pulse waveform of this exemplary embodiment as shown in FIG. 16, a method for delaying an output signal slightly by connecting a buffer circuit to an output part of the power supply unit (not shown) may be adopted. Alternatively, pulse waveforms may be controlled positively by adding a timing adjustment circuit.

### Fifth Exemplary Embodiment

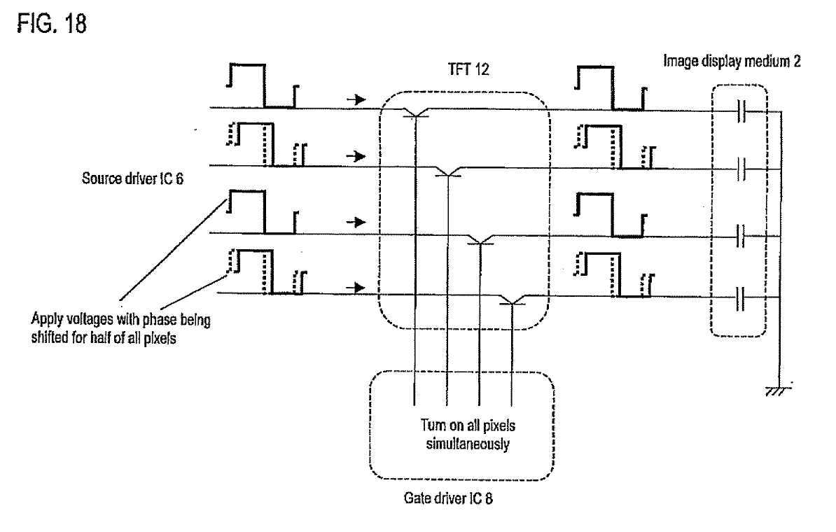

FIG. 18 is a schematic chart showing a sequence control of the source driver IC 6 and the gate driver IC 8 according to the fifth exemplary embodiment. In this exemplary embodiment, the source driver IC 6 and the gate driver IC 8 are controlled by the control unit 10 in accordance with this chart.

In this exemplary embodiment, like the first exemplary embodiment shown in FIG. 10, the gate voltages are applied collectively to all the pixels by the gate driver IC 8 to bring all the pixels into the ON state simultaneously, as shown in FIG. 18. Therefore, the same effect as the first exemplary embodiment can be obtained, that is, the initialization voltage can be applied to each pixel for the entire reset (initialization) time. Thereby the reset time can be shortened while securing the required application time. The more initialization voltage can be applied to each pixel by securing the long application time, and the initialized image more uniform in the whole area can be easily produced in the same way, as compared with the method for scanning each pixel.

In this exemplary embodiment, all pixels are divided into two pixel groups, and the source driver IC 6 is controlled to apply the source voltages while shifting the phases of pulse voltages (source voltage) between the pixel groups.

As described with reference to FIGS. 16 and 17 in the fourth exemplary embodiment, the current value abruptly increases due to a steep rise of voltage in each pulse of the so-called rectangular wave. Therefore, in the configuration of the exemplary embodiments of the invention in which the gate driver IC 8 performs switching so that the source voltages are applied collectively to all the pixels, an increase in current value at the rising portions of the pulses occurs in all the pixels simultaneously, so that an instantaneous large current flows at once. Thus, in this exemplary embodiment, the source voltages are applied to the respective halves of all the pixels while shifting the phases of the source voltages between the halves of the pixels. Thereby, the peak of current flowing instantaneously is divided into two, to decrease the maximum current value to half. Therefore, the power supply unit having a lower capacity and driver ICs and other electric components having lower durability against large current can be selected. Also, the degree of freedom in design increases, and the reduction in size and costs of the image display medium and the image display device can be achieved.

In order to obtain the effect equivalent to or greater than this exemplary embodiment, it is not required to divide all pixel into two pixel groups, but it may be possible to divide all into three or more pixel groups, and the phases of source voltages for the respective pixel groups may be shifted from each other. As the number of pixel groups becomes larger, the effect of reducing the maximum current value gets higher, but the control becomes more complex. Thus, all pixels may be divided at an appropriate degree from the viewpoint of the desired effect and the easiness.

With regard to the degree of phase shift of the source voltages between the pixel groups, the effect of reducing the maximum current value is achieved if the phases are shifted even slightly. However, it is preferable to set up timings so that a rising portion of a pulse voltage in a next pixel group starts after the peak of a current value is sufficiently decreased. Of course, phases for two pixel groups may be reversed, namely, shifted by 180° as in the second exemplary embodiment, or phases for four pixel groups may be shifted by 90° as in the third exemplary embodiment. Thereby, the effect of suppressing the maximum current value equivalent to or greater than this exemplary embodiment can be achieved.

The effect of suppressing the maximum current value specific to the exemplary embodiment can be achieved by dividing all pixels into several pixel groups, and shifting the phases of the source voltages between the pixel groups. However, is effect is different from the flicker suppression effect depending on the arrangement of pixels. Therefore, these pixel groups may be mixed or arranged separately in specific areas. Of course, the mixed arrangement of these pixel groups is preferable to achieve the effect of suppressing the maximum current value and the effect of suppressing the flicker.

The exemplary embodiments of the invention have been described above taking the image display device shown in FIGS. 1 and 2 as an example. However, the invention is not limited thereto. The above exemplary embodiments may be modified appropriately based on the knowledge of one skilled in the art. Such modification is also included within the scope of the invention, so far as the modification result is provided with the configuration of the invention.

The image display medium using the moving particles of three colors of red, white and black has been exemplified in the exemplary embodiments. However, the image display medium is not limited thereto. The invention may be applied to any electrophoresis-type image display medium such as a display medium containing moving particles of one color, particles of two colors of white and black, particles of three colors of yellow, magenta and cyan to form a full-color image, or immovable colored particles that are further enclosed or arranged. In this sense, even if a part of the display layer is formed by arranging microcapsules having the moving particles dispersed in the dispersion medium, there is no problem to apply the invention thereto.

To achieve the above effects, the drive device for the image display medium and the image display device having the configuration of any of the exemplary embodiments may be controlled to perform the driving as described in the section <Driving at the time of Initializing the Image Display Medium>. Also, if a computer is used as a control unit that performs the above control according to any of the exemplary embodiments and if a program that causes to execute the method for initializing the image display medium according to any of the above exemplary embodiments is installed into the computer, for example, from a computer-readable medium (e,g., CD-R, DVD-R, USB memory or the like), the above effects can also be achieved.

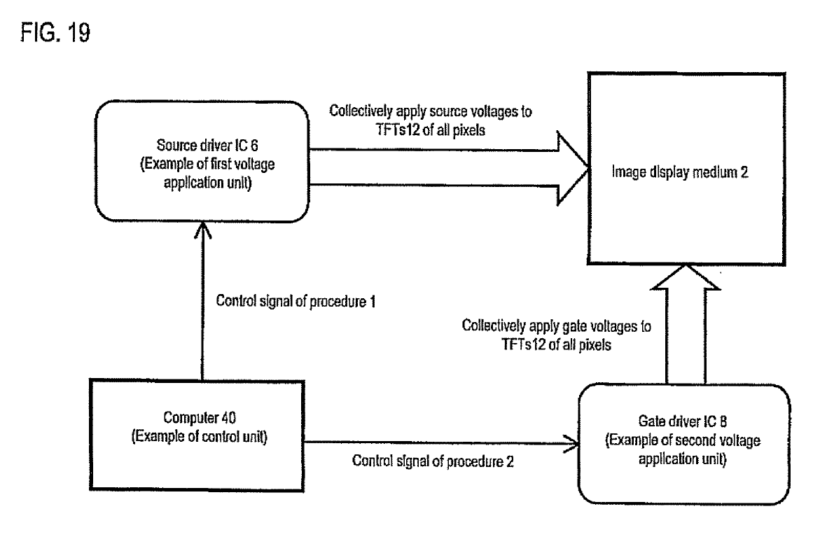

Referring to a block diagram of FIG. 19, the initialization program according to one exemplary embodiment will be described below. Herein, FIG. 19 is a block diagram for explaining the program for initializing for the image display medium.

In the initialization program, first of all, a control signal of procedure 1 is sent from the computer (an example of a control unit) 40 to the source driver IC (an example of a first voltage application unit) 6, and the source driver IC 6 collectively applies the source voltages to the TFTs 12 of all the pixels in the image display medium 2 in accordance with the control signal.

Next, a control signal of procedure 2 is sent from the computer 40 to the gate driver IC 8, and the gate driver IC 8 collectively applies the gate voltages to the TFTs 12 of all the pixels in the image display medium 2 in accordance with the control signal.

After the source voltages and the gate voltages are applied to the TFTs 12 for a sufficient time for initializing the image display medium 2, a control signal (not shown) of releasing the application of voltages is sent from the computer 40 to the source driver IC 6 and the gate driver IC 8. Thereby, the initialization operation ends.

The initialization program enables the computer to perform the above procedures. The procedures 1 and 2 may be performed in this order, performed substantially at the same time, or performed in reverse order. There is no problem if the control is made such that the application of the source voltages in the procedure 1 and the application of the gate voltages in the procedure 2 are performed at the same time, to thereby apply to the display layer 30 a voltage required to form the initialization image.

The initialization program can perform the procedure 1 and the procedure 2 in accordance with the control signals as described in the second to fifth exemplary embodiments. The suitable driving for initialization described in the second to fifth exemplary embodiments can be realized by performing the procedure 1 and/or procedure 2, which involve the control signals as described in the second to fifth exemplary embodiments.

What is claimed is:

1. A driver for an image display medium having
a pair of substrates that face each other with a gap,
a common electrode that is disposed in a whole surface of one of the substrates,
pixel electrodes that are arranged for respective pixels constituting rows and columns on the other substrate;
a display layer in which groups of moving particles that move between the substrates in accordance with an electric field are dispersed in a dispersion medium enclosed between the substrates, and
transistors that are connected to the pixel electrodes, respectively, each transistor for controlling a voltage to be applied to the corresponding pixel, the driver comprising;,
a first voltage application unit, wherein in initializing the image display medium and in writing an image into the image display medium, the first voltage application unit can apply voltages to source electrodes of the transistors of all the pixels or each column collectively;
a second voltage application unit that can select each row of the transistors successively and apply voltages to gate electrodes of the transistors of each selected row; and
a control unit that controls the first voltage application unit and the second voltage application unit, wherein
in initializing the image display medium, the control unit controls the first and second voltage application units so that the second voltage application unit applies the voltages to the gate electrodes of the transistors of all the pixels collectively while the first voltage application unit is applying the voltages to the source electrodes of the transistors of all the pixels collectively.

2. The driver for the image display medium according to claim 1, wherein
in initializing the image display medium, the control unit controls the first voltage application unit so that the image display medium is divided into a plurality of pixel groups, and
waveforms of the voltages applied to the source electrodes of the transistors of each pixel group are different in phase from those of the voltages applied to the source electrodes of the transistors of the other pixel groups.

3. The driver for the image display medium according to claim 1, wherein
in initializing the image display medium, the control unit controls the first voltage application unit so that the image display medium is divided into a plurality of pixel groups,
waveforms of the voltages applied to the source electrodes of the transistors of each pixels group are reversed with respect to those of the voltages applied to the source electrodes of the transistors of corresponding one of the pixels groups, and
the pixels belonging to the plurality of pixel groups are mixed.

4. The driver for the image display medium according to claim 1, wherein
the groups of moving particles in the image display medium include a plurality of kinds of particle groups having different colors from each other and having difference forces that are required for separation from the substrates,
in initializing the image display medium, the control unit controls the first voltage application unit so that the image display medium is divided into a plurality of pixel groups,
waveforms of the voltages applied to the source electrodes of the transistors of each pixel group are different in phase from those of the voltages applied to the source electrodes of the transistors of the other pixel groups, and
the pixels belonging to the plurality of pixel groups are mixed.

5. The driver for the image display medium according to claim 1, wherein in initializing the image display medium, waveforms of the voltages applied to the source electrodes of the transistors are controlled so as to have gradients in rising portions of the waveforms.

6. The driver for the image display medium according to claim 1, wherein the control unit is configured so that the control unit performs the initializing for applying the voltages to the gate electrodes of the transistors of all the pixels collectively, before performing the image writing in which the second voltage application unit selects pixels and applies the voltages to the gate electrodes of the transistors of the selected pixels while the first voltage application unit is applying the voltages to the source electrodes of the transistors of all the pixels or each column collectively.

7. An image display device comprising:
an image display medium including
a pair of substrates that face each other with a gap,
a common electrode that is disposed in a whole surface of one of the substrates,
pixel electrodes that are arranged for respective pixels constituting rows and columns on the other substrate;
a display layer in which groups of moving particles that move between the substrates in accordance with an electric field are dispersed in a dispersion medium enclosed between the substrates, and
transistors that are connected to the pixel electrodes, respectively, each transistor for controlling a voltage to be applied to the corresponding pixel;
a first voltage application unit, wherein in initializing the image display medium and in writing an image into the image display medium, the first voltage application unit can apply voltages to source electrodes of the transistors of all the pixels or each column collectively;
a second voltage application unit that can select each row of the transistors successively and apply voltages to gate electrodes of the transistors of each selected row;, and
a control unit that controls the first voltage application unit and the second voltage application unit, wherein
in initializing the image display medium, the control unit controls the first and second voltage application units so that the second voltage application unit applies the voltages to the gate electrodes of the transistors of all the pixels collectively while the first voltage application unit is applying the voltages to the source electrodes of the transistors of all the pixels collectively.

8. The image display device according to claim 7, wherein
in initializing the image display medium, the control unit controls the first voltage application unit so that the image display medium is divided into a plurality of pixel groups, and
waveforms of the voltages applied to the source electrodes of the transistors of each pixel group are different in phase from those of the voltages applied to the source electrodes of the transistors of the other pixel groups.

9. The image display device according to claim 7, wherein
in initializing the image display medium, the control unit controls the first voltage application unit so that the image display medium is divided into a plurality of pixel groups,
waveforms of the voltages applied to the source electrodes of the transistors of each pixels group are reversed with respect to those of the voltages applied to the source electrodes of the transistors of corresponding one of the pixels groups, and
the pixels belonging to the plurality of pixel groups are mixed.

10. The image display device according to claim 7, wherein
the groups of moving particles in the image display medium include a plurality of kinds of particle groups having different colors from each other and having difference forces that are required for separation from the substrates,
in initializing the image display medium, the control unit controls the first voltage application unit so that the image display medium is divided into a plurality of pixel groups,
waveforms of the voltages applied to the source electrodes of the transistors of each pixel group are different in phase from those of the voltages applied to the source electrodes of the transistors of the other pixel groups, and
the pixels belonging to the plurality of pixel groups are mixed.

11. The image display device according to claim 7, wherein in initializing the image display medium waveforms of the voltages applied to the source electrodes of the transistors are controlled so as to have gradients in rising portions of the waveforms.

12. The image display device according to claim 7, wherein the control unit is configured so that the control unit performs the initializing for applying the voltages to the gate electrodes of the transistors of all the pixels collectively, before performing the image writing in which the second voltage application unit selects pixels and applies the voltages to the gate electrodes of the transistors of the selected pixels while the first voltage application unit is applying the voltages to the source electrodes of the transistors of all the pixels or each column collectively.

13. A method for initializing an image display medium having
a pair of substrates that face each other with a gap,
a common electrode that is disposed in a whole surface of one of the substrates,
pixel electrodes that are arranged for respective pixels constituting rows and columns on the other substrate;
a display layer in which groups of moving particles that move between the substrates in accordance with an electric field are dispersed in a dispersion medium enclosed between the substrates, and
transistors that are connected to the pixel electrodes, respectively, each transistor for controlling a voltage to be applied to the corresponding pixel,
the method comprising:
a first procedure of applying voltages to the source electrodes of the transistors of all the pixels collectively; and
a second procedure of applying voltages to the gate electrodes of the transistors of all the pixels collectively while continuing the applying of the voltages in the first procedure.

14. A computer-readable medium storing a program that causes a computer to execute an initialization process for an image display medium, the image display medium having
a pair of substrates that face each other with a gap,
a common electrode that is disposed in a whole surface of one of the substrates,
pixel electrodes that are arranged for respective pixels constituting rows and columns on the other substrate;
a display layer in which groups of moving particles that move between the substrates in accordance with an electric field are dispersed in a dispersion medium enclosed between the substrates, and
transistors that are connected to the pixel electrodes, respectively, each transistor for controlling a voltage to be applied to the corresponding pixel, the initialization process comprising:
a first procedure of applying voltages to the source electrodes of the transistors of all the pixels collectively; and
a second procedure of applying voltages to the gate electrodes of the transistors of all the pixels collectively while continuing the applying of the voltages in the first procedure.
